(19) United States
(12) Patent Application Publication
(10) Pub. No.: US 2017/0165995 A1
(43) Pub. Date: Jun. 15, 2017

(54) U-shaped binding element, its manufacture method and application

(71) Applicant: Shenzhen QUPA Office Equipment Co., Ltd, Shenzhen (CN)

(72) Inventor: Zeyan Ying, Shenzhen (CN)

(73) Assignee: Shenzhen QUPA Office Equipment Co., Ltd

(21) Appl. No.: 15/442,708

(22) Filed: Feb. 27, 2017

(30) Foreign Application Priority Data
Dec. 22, 2016 (CN) 201611200835.7

(51) Int. Cl. B42D 3/00; B42C 7/00

(52) U.S. Cl. CPC B42D 3/002; B42C 7/00

(57) ABSTRACT

A u-shaped binding element comprising a u-shaped element main body made of steel material or aluminium alloy which is molded by a tension process, wherein one or two up ends of the u-shaped element main body is or are wrapped with anti-drop adhesive tape; wherein if one up end of the u-shaped element main body is winded with the anti-drop adhesive tape, a single-side molding body is formed; if two ends of the u-shaped element main body are covered with are respectively winded with the anti-drop adhesive tape, a double-side molding body is formed, a wrapage is covered on an external surface of the single-side molding body or the double-side molding body to form the u-shaped binding element. Utilizing the binding sleeve and a binding machine is capable of quickly completing text sheet binding and effectively solving the first requirement of binding: convenient and reliable, so as to make the binding more reliable, fast and convenient.

### CROSS REFERENCE OF RELATED APPLICATION

The present application claims priority under 35 U.S.C. 119(a-d) to CN 201611200835.7, filed Dec. 22, 2016.

### BACKGROUND OF THE PRESENT INVENTION

Field of Invention

The present invention relates to an office binding supply, and more particularly to a u-shaped binding element, its manufacture method and application.

Description of Related Arts

The first demand for office binding supplies is reliable, wherein there shouldn't be any missing page or pages shouldn't be missed during the process of looking through, which represents a poor reliability; the second demand for office binding supplies is a high work efficiency, wherein a complicated or a step-by-step operation standard will make the work efficiency greatly reduced; and the third requirement therefor is appearance and etc.

Currently, the office binding generally utilizes two manners comprising hole punching and hot-melt adhering binding. As the name suggests, hole binding means punching hole on the text pages and then binding the text pages utilizing various kinds of binding materials. The hole punching generally does not need any prefabricated binding sleeve, and this conventional office binding method has shortcomings of tedious operations and low working efficiency. Hot-melt adhering binding means utilizing a prefabricated sleeve and coating an internal side of the back cover with hot melt adhesive, so as to achieve binding the text page by heating with a hot-melt binding machine. Though the hot-melt adhering binding is more convenient than hole binding, binding effect thereof is worse.

There is also a third binding method: channel bind, metal bind, wherein the sleeve utilized therein is pre-provided with a metal u-shaped element, and the binding objects are achieved by clamping the u-shaped element by a binding machine. The main drawbacks of the binding are as follows. Due to the resilient nature of the metal deformation, the phenomenon that a single page falling off the text causes page-by-page off exists, and the phenomenon especially easy occurs when binding only a few copies of the text.

### SUMMARY OF THE PRESENT INVENTION

Accordingly, in order to accomplish the above objects, the present invention provides a u-shaped binding element, it manufacture method and application.

In order to achieve the objects mentioned above, the present invention provides a u-shaped binding element comprising a u-shaped element main body made of steel material or aluminium alloy which is molded by a tension process, wherein one or two up ends of the u-shaped element main body is or are wrapped with anti-drop adhesive tape; wherein if one up end of the u-shaped element main body is winded with the anti-drop adhesive tape, a single-side molding body is formed; if two ends of the u-shaped element main body are covered with are respectively winded with the anti-drop adhesive tape, a double-side molding body is formed, a wrapage is covered on an external surface of the single-side molding body or the double-side molding body to form the u-shaped binding element.

Preferably, the u-shape element main body is formed by punching a steel plate into a u shape via a punching machine.

Preferably, the anti-drop adhesive tape is made of rubber, silicone or plastic cement.

Preferably, the wrappage is made of paper, cloth or plastic cement.

In order to achieve the objects mentioned above, the present invention further provides a method for manufacturing the u-shaped binding element, comprising following steps of:

(1) punching a suitable steel plate into a u shape via a punching machine;

(2) wrapping one or two up ends of the u-shaped element main body with anti-drop adhesive tape to form a single-side molding body or a double-side molding body;

(3) covering an external surface of the single-side molding body or the double-side molding body with a wrappage to form the u-shaped binding element.

In order to achieve the objects mentioned above, the present invention further provides an application of the u-shaped binding element comprising steps of: combining the u-shaped binding element with a second back cover-front cover-spine cover to form a simple type binding sleeve; a specific method for manufacturing the simple type binding sleeve comprising steps of: embedding an integral body of a back cover-front cover-spine cover which is pre-packed in a middle of a u-shaped binding element, wherein the back cover-front cover-spine cover is made of paper or photographic film.

Preferably, the application of the u-shaped binding element further comprises steps of putting one end of a text sheet requiring binding into the simple type binding sleeve; and tightly pressing the text page and the binding sleeve by a press-binding machine.

In order to achieve the objects mentioned above, the present invention further provides an application of the u-shaped binding element comprising steps of: combining the u-shaped binding element with a second back cover-front cover-spine cover to form a hardcover binding sleeve; wherein the second back cover-front cover-spine cover 13b has a certain hardness and adopts a u-shaped binding element with two up ends covered with anti-drop adhesive tape; wherein a specific method for manufacturing the hardcover binding sleeve comprising steps of: forming the u-shaped binding element into a plate to form a plate-shape structure; covering the plate-shape structure on a middle portion of the first-back cover-front cover-spine cover; connecting both ends of the plate-shape structure with both ends of the back cover-front cover-spine cover; and hydraulic molding the plate-shape structure and the back cover-front cover-spine cover to form a hardcover binding sleeve.

Preferably, the second back cover-front cover-spine cover comprises an external surface, an internal surface and two internal core, wherein the internal core is made of paper plate, in such a manner that the hardcover binding sleeve has a certain hardness; a middle portion of the external surface and a middle portion of the internal surface are closely laminated to form a first wrapping chamber, wherein the plate-shape structure is wrapped in the first wrapping chamber, and a first portion of both ends of the external surface and a first portion of both ends of the internal surface are fixedly pressed to form a connecting portion; a second portion of both ends of the external surface and a second portion of both ends of the internal surface are closely laminated to form a second wrapping chamber, each internal core is wrapped in the second wrapping chamber which is corresponded; both ends of the first wrapping chamber is connected with a second wrapping chamber via the connecting portion which is corresponded.

Preferably, the application of the u-shaped binding element further comprises putting one end of the text sheet into the hardcover binding sleeve, and tightly pressing the text sheet and the binding sleeve by a press-binding machine.

Beneficial effects of the present invention are as follows. Compared with the conventional art, the u-shaped binding element, its manufacture method and application provided by the present invention adopts pressing steel material to form the u-shaped element main body, wherein one up end or two up ends of the u-shaped element main body is or are wrapped with anti-drop adhesive tape and a wrappage is wrapped on an external surface of the u-shaped element main body wrapped with the anti-drop adhesive tape. The anti-drop adhesive tape added is capable of effectively decrease the bounding effect while metal clamping, i.e., the spring back amount of the anti-drop adhesive tape is greater than the spring back amount after the deformation of the u-shaped element main body. The position of the anti-drop adhesive tape is provided between the wall of the u-shaped element main body and the text sheet, and the anti-drop adhesive tape which is not capable of rebounding has an effect of preventing loose pages, so as to achieve the object of reliable binding. Thus, the u-shaped binding element and each kinds of back cover-front cover-spine cover are combined to form the binding sleeve. Utilizing the binding sleeve and a binding machine is capable of quickly completing text sheet binding and effectively solving the first requirement of binding: convenient and reliable, so as to make the binding more reliable, fast and convenient.

These and other objectives, features, and advantages of the present invention will become apparent from the following detailed description, the accompanying drawings, and the appended claims.

### BRIEF DESCRIPTION OF THE DRAWINGS

FIG. 1 is a sketch view of a u-shaped binding element according to a first preferred embodiment of the present invention.

FIG. 2 is a sketch view of the u-shaped binding element according to a second preferred embodiment of the present invention.

FIG. 3 is a structural sketch view of the u-shaped binding element of the present invention, wherein the u-shaped binding element has two concaves at two corners thereof, so as to facilitate clamping and decrease resilience.

FIG. 4 is a structural sketch view of a second step of a manufacture method of the u-shaped binding element of the present invention.

FIG. 5 is a structural sketch view of a simple type binding sleeve of the present invention.

FIG. 6 is a sketch view of a first step of a bookbinding process utilizing the simple type binding sleeve of the present invention.

FIG. 7 is a sketch view of a second step of the bookbinding process utilizing the simple type binding sleeve of the present invention.

FIG. 8 is a structural sketch view of a hardcover type binding sleeve before forming according to a preferred embodiment of the present invention.

FIG. 9 is a structural sketch view of a hardcover type binding sleeve after hydro-forming according to a preferred embodiment of the present invention.

Reference numbers of main elements are as follows:

10-u-shape element main body; 11-anti-drop adhesive tape; 12-wrappage; 13a-first-back cover-front cover-spine cover; 13b-second back cover-front cover-spine cover; 14-text; 131b-external surface; 132b-internal surface; 133b-internal core.

### DETAILED DESCRIPTION OF THE PREFERRED EMBODIMENT

In order to illustrate the present invention more apparently, further description of the present invention is illustrated in detail.

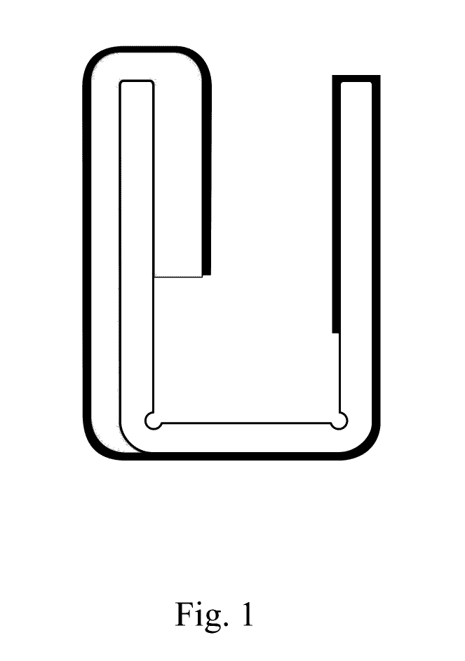

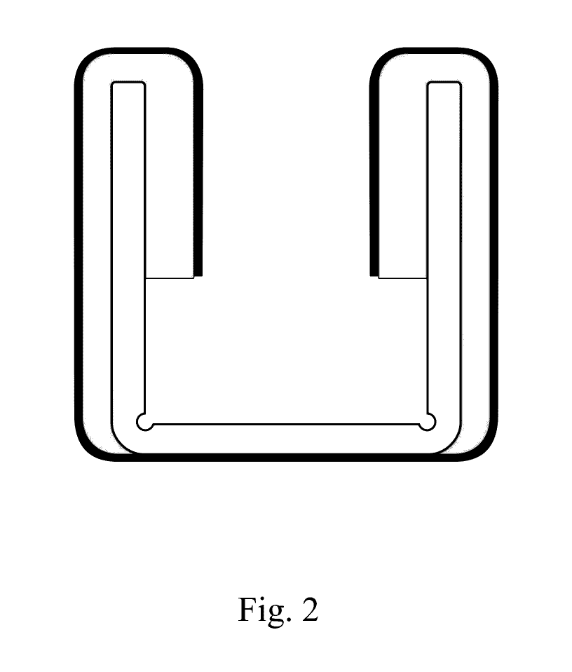

Referring to FIGS. 1-2 of the drawings, according to a preferred embodiment of the present invention is illustrated, a u-shaped binding element comprising a u-shaped element main body 10 made of steel material, wherein one or two up ends of the u-shaped element main body 10 is or are wrapped with anti-drop adhesive tape 11; wherein if one up end of the u-shaped element main body 10 is winded with the anti-drop adhesive tape 11, a single-side molding body is formed; if two ends of the u-shaped element main body 10 are covered with are respectively winded with the anti-drop adhesive tape 11, a double-side molding body is formed, a wrapage 12 is covered on an external surface of the single-side molding body or the double-side molding body to form the u-shaped binding element.

In the preferred embodiment, the u-shape element main body 10 is formed by punching a steel plate into a u shape via a punching machine. The anti-drop adhesive tape 11 can be made of rubber, silicone, plastic cement or other material. The wrappage 12 is made of paper, cloth or plastic cement, and other material is all right.

Referring to FIG. 3-4 and FIG. 1, the present invention further provides a method for manufacturing the u-shaped binding element, comprising following steps of:

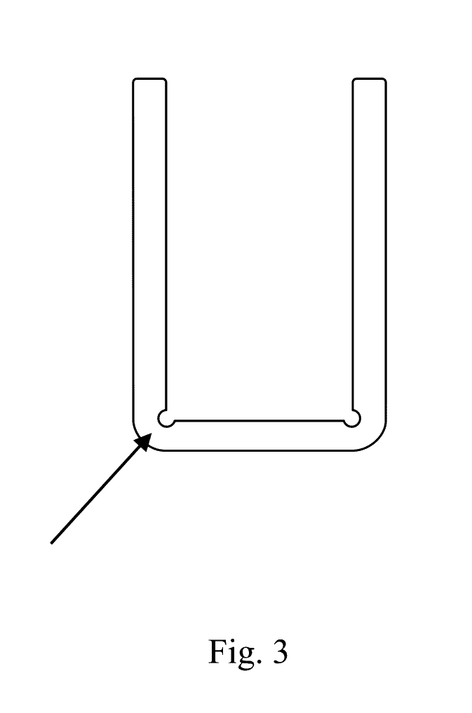

(1) punching a suitable steel plate into a u shape via a punching machine, referring to FIG. 3;

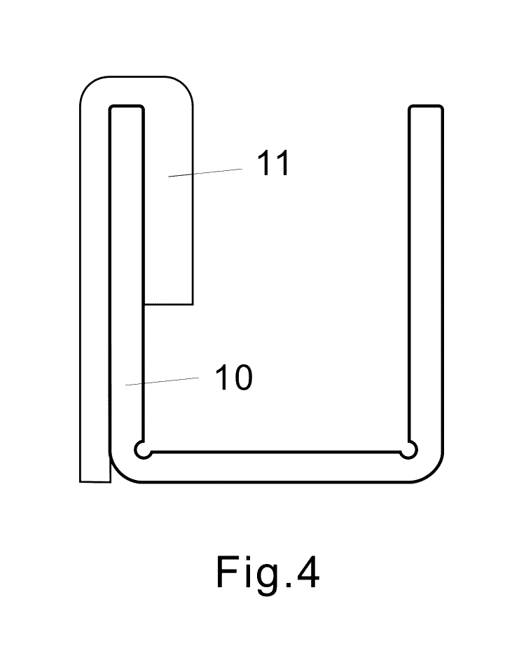

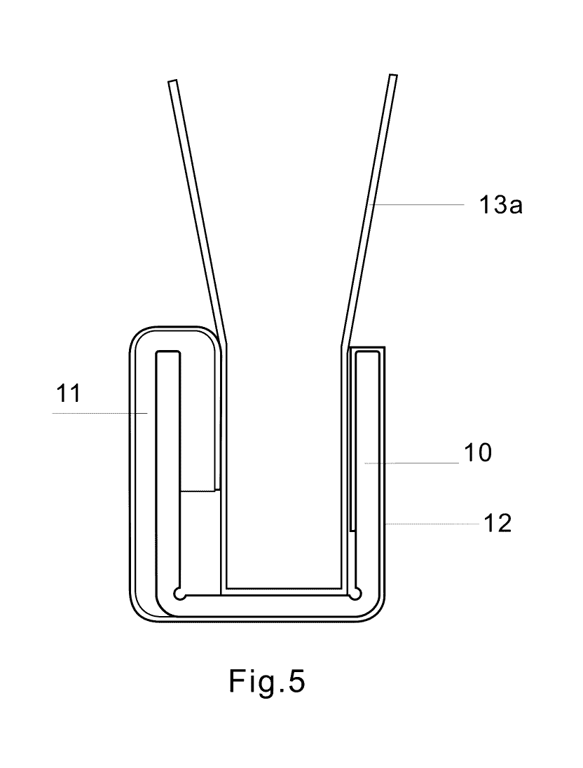

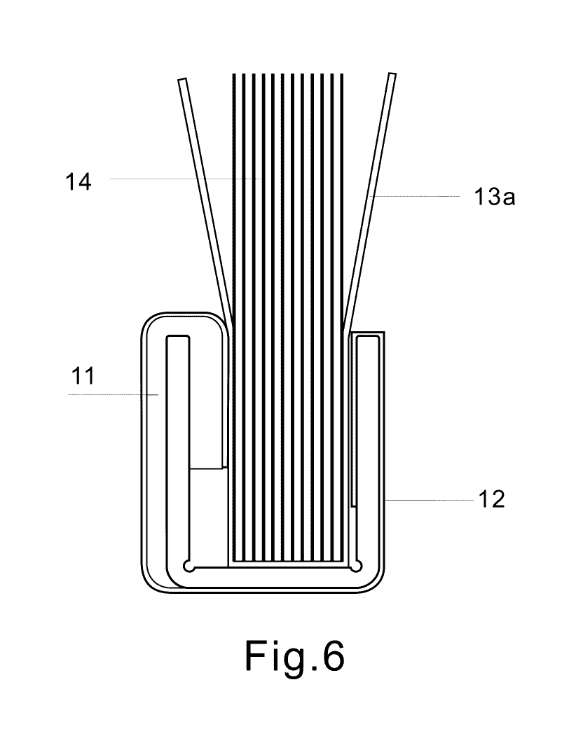

(2) wrapping one or two up ends of the u-shaped element main body 10 with anti-drop adhesive tape 11 to form a single-side molding body or a double-side molding body, referring to FIG. 4;

(3) covering an external surface of the single-side molding body or the double-side molding body with a wrappage 12 to form the u-shaped binding element.

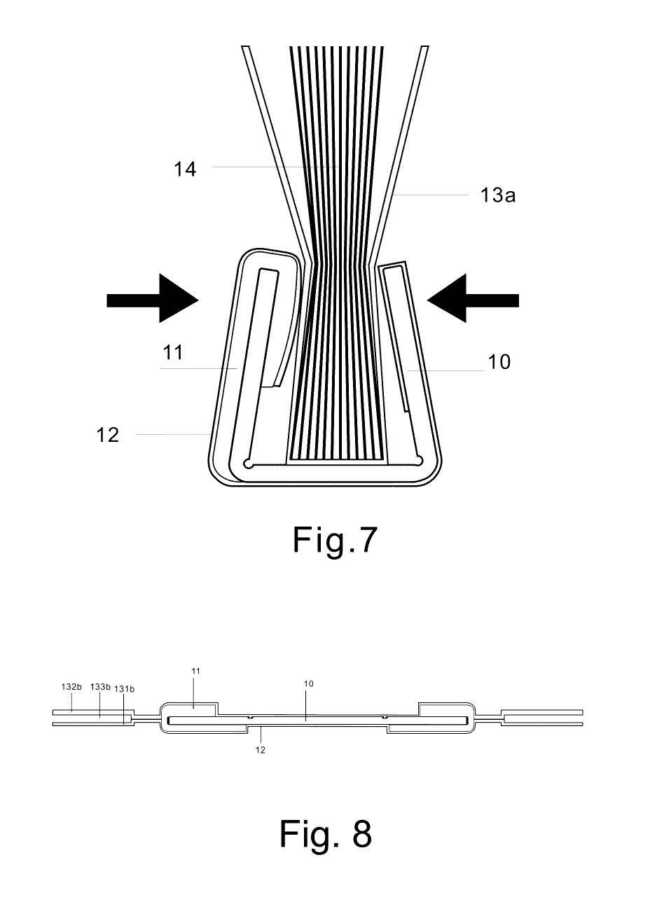

A specific method for manufacturing a simple type binding sleeve comprising steps of: embedding an integral body of a back cover-front cover-spine cover which is pre-packed in a middle of a u-shaped binding element, wherein the back cover-front cover-spine cover is made of paper or photographic film; putting one end of a text sheet 14 requiring binding into the simple type binding sleeve; and tightly pressing the text page and the binding sleeve by a press-binding machine; wherein a final press result is as shown in FIG. 7.

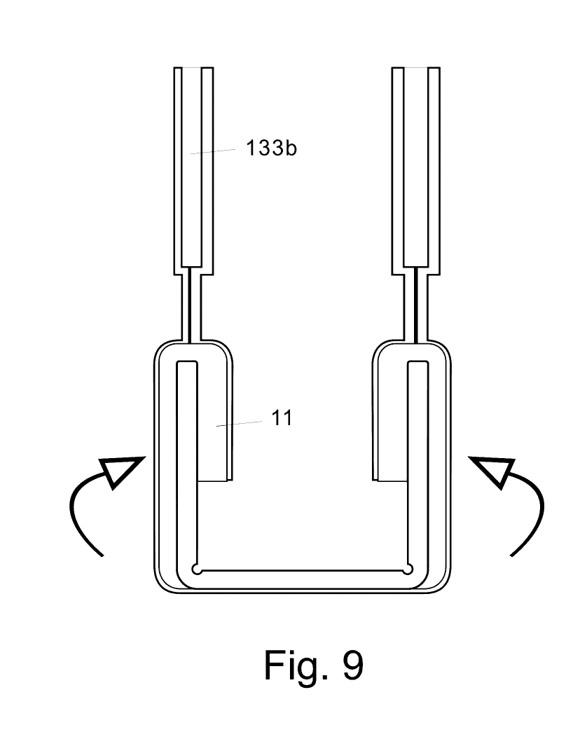

Further, referring to FIG. 8-9, the present invention further provides an application of the u-shaped binding element comprising steps of: combining the u-shaped binding element with a second back cover-front cover-spine cover 13b to form a hardcover binding sleeve; wherein the second back cover-front cover-spine cover 13b has a certain hardness and adopts a u-shaped binding element with two up ends covered with anti-drop adhesive tape; wherein a specific method for manufacturing the hardcover binding sleeve comprising steps of: forming the u-shaped binding element into a plate to form a plate-shape structure; covering the plate-shape structure on a middle portion of the first-back cover-front cover-spine cover; connecting both ends of the plate-shape structure with both ends of the back cover-front cover-spine cover; and hydraulic molding the plate-shape structure and the back cover-front cover-spine cover to form a hardcover binding sleeve as shown in FIG. 9.

In the preferred embodiment, the second back cover-front cover-spine cover 13b comprises an external surface 131b, an internal surface 132b and two internal core 133b, wherein the internal core is made of paper plate, in such a manner that the hardcover binding sleeve has a certain hardness; a middle portion of the external surface and a middle portion of the internal surface are closely laminated to form a first wrapping chamber, wherein the plate-shape structure is wrapped in the first wrapping chamber, and a first portion of both ends of the external surface and a first portion of both ends of the internal surface are fixedly pressed to form a connecting portion; a second portion of both ends of the external surface and a second portion of both ends of the internal surface are closely laminated to form a second wrapping chamber, each internal core is wrapped in the second wrapping chamber which is corresponded; both ends of the first wrapping chamber is connected with a second wrapping chamber via the connecting portion which is corresponded; and finally putting one end of the text sheet into the hardcover binding sleeve, and tightly pressing the text sheet and the binding sleeve by a press-binding machine.

Compared with the conventional art, the u-shaped binding element, its manufacture method and application provided by the present invention adopts pressing steel material to form the u-shaped element main body, wherein one up end or two up ends of the u-shaped element main body is or are wrapped with anti-drop adhesive tape and a wrappage is wrapped on an external surface of the u-shaped element main body wrapped with the anti-drop adhesive tape. The anti-drop adhesive tape added is capable of effectively decrease the bounding effect while metal clamping, i.e., the spring back amount of the anti-drop adhesive tape is greater than the spring back amount after the deformation of the u-shaped element main body. The position of the anti-drop adhesive tape is provided between the wall of the u-shaped element main body and the text sheet, and the anti-drop adhesive tape which is not capable of rebounding has an effect of preventing loose pages, so as to achieve the object of reliable binding. Thus, the u-shaped binding element and each kinds of back cover-front cover-spine cover are combined to form the binding sleeve. Utilizing the binding sleeve and a binding machine is capable of quickly completing text sheet binding and effectively solving the first requirement of binding: convenient and reliable, so as to make the binding more reliable, fast and convenient.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A u-shaped binding element comprising a u-shaped element main body made of steel material or aluminium alloy which is molded by a tension process, wherein one or two up ends of the u-shaped element main body is or are wrapped with anti-drop adhesive tape; wherein if one up end of the u-shaped element main body is winded with the anti-drop adhesive tape, a single-side molding body is formed; if two ends of the u-shaped element main body are covered with are respectively winded with the anti-drop adhesive tape, a double-side molding body is formed, a wrapage is covered on an external surface of the single-side molding body or the double-side molding body to form the u-shaped binding element.

2. The u-shaped binding element, as recited in claim 1, wherein the u-shape element main body is formed by punching a steel plate into a u shape via a punching machine.

3. The u-shaped binding element, as recited in claim 1, wherein the anti-drop adhesive tape is made of rubber, silicone or plastic cement.

4. The u-shaped binding element, as recited in claim 1, wherein the wrappage is made of paper, cloth or plastic cement.

5. A method for manufacturing a u-shaped binding element, comprising following steps of:
(1) punching a suitable steel plate into a u shape via a punching machine;
(2) wrapping one or two up ends of the u-shaped element main body with anti-drop adhesive tape to form a single-side molding body or a double-side molding body;
(3) covering an external surface of the single-side molding body or the double-side molding body with a wrappage to form the u-shaped binding element.

6. An application of the u-shaped binding element comprising steps of: combining the u-shaped binding element with a second back cover-front cover-spine cover to form a simple type binding sleeve; a specific method for manufacturing the simple type binding sleeve comprising steps of: embedding an integral body of a back cover-front cover-spine cover which is pre-packed in a middle of a u-shaped binding element, wherein the back cover-front cover-spine cover is made of paper or photographic film.

7. The application of the u-shaped binding element, as recited in claim 6, further comprising steps of putting one end of a text sheet requiring binding into the simple type binding sleeve; and tightly pressing the text page and the binding sleeve by a press-binding machine.

8. An application of the u-shaped binding element comprising steps of: combining the u-shaped binding element with a second back cover-front cover-spine cover to form a hardcover binding sleeve; wherein the second back cover-front cover-spine cover 13b has a certain hardness and adopts a u-shaped binding element with two up ends covered with anti-drop adhesive tape; wherein a specific method for manufacturing the hardcover binding sleeve comprising steps of: forming the u-shaped binding element into a plate to form a plate-shape structure; covering the plate-shape structure on a middle portion of the first-back cover-front cover-spine cover; connecting both ends of the plate-shape structure with both ends of the back cover-front cover-spine cover; and hydraulic molding the plate-shape structure and the back cover-front cover-spine cover to form a hardcover binding sleeve.

9. The application of the u-shaped binding element, as recited in claim 8, wherein the second back cover-front cover-spine cover comprises an external surface, an internal surface and two internal core, wherein the internal core is made of paper plate, in such a manner that the hardcover binding sleeve has a certain hardness; a middle portion of the external surface and a middle portion of the internal surface are closely laminated to form a first wrapping chamber, wherein the plate-shape structure is wrapped in the first wrapping chamber, and a first portion of both ends of the external surface and a first portion of both ends of the internal surface are fixedly pressed to form a connecting portion; a second portion of both ends of the external surface and a second portion of both ends of the internal surface are closely laminated to form a second wrapping chamber, each internal core is wrapped in the second wrapping chamber which is corresponded; both ends of the first wrapping chamber is connected with a second wrapping chamber via the connecting portion which is corresponded.

10. The application of the u-shaped binding element, as recited in claim 8, further comprising putting one end of the text sheet into the hardcover binding sleeve, and tightly pressing the text sheet and the binding sleeve by a press-binding machine.
